(19) United States
(12) Patent Application Publication
(10) Pub. No.: US 2022/0122130 A1
(43) Pub. Date: Apr. 21, 2022

(54) Smartphone-Specific Software-Based Grading Service for Trading Cards

(71) Applicant: Vincent Porter, Chicago, IL (US)

(72) Inventor: Vincent Porter, Chicago, IL (US)

(21) Appl. No.: 17/400,868

(22) Filed: Aug. 12, 2021

Related U.S. Application Data
(60) Provisional application No. 63/094,057, filed on Oct. 20, 2020.

(51) Int. Cl. G06Q 30/02; G06Q 30/00; G06K 19/06; G06F 16/51; G06F 16/23; G06T 7/00

(52) U.S. Cl. CPC G06Q 30/0278; G06Q 30/0185; G06K 19/0614; G06T 2207/10048; G06F 16/2379; G06T 7/0002; G06T 2207/30168; G06F 16/51

(57) ABSTRACT

A system for grading and valuating memorabilia having a computer, a user device in communication with said computer having a camera and attributes pertaining to the quality of images taken by said camera, an image of memorabilia provided to said computer that shows a condition of the memorabilia, a grade associated with the condition of the memorabilia determined by the computer based on at least one of the image and the attributes, the computer providing an identification of the memorabilia to a database, a plurality of images of other memorabilia and a plurality of grades and a plurality of values associated therewith provided to said computer by said database, and a valuation for the memorabilia determined by comparing the grade for the memorabilia with at least one of the plurality of grades for the other memorabilia and assigning a valuation based on at least one of the corresponding values.

### TECHNICAL FIELD

The present invention relates to a system for grading and valuating memorabilia.

### BACKGROUND

Collectables and memorabilia sales are a large market for used goods, where the authenticity, grade, and value of items sold over the Internet is uncertain at best.

Traditionally, steps to mitigate the uncertainty are costly and take undue time. Currently, over three million trading cards (baseball, basketball, hockey, Pokémon, etc.) are graded annually by one of three companies: PSA (a division of Collector's Universe “CLOT”), Beckett, and SGC. The demand for graded cards outstrips the supply of quality grading services. PSA, the market leader, has turnaround times of over 40 business days for its “regular” service which costs $50 per card.

Each of these “third-party authenticators” has been in business for over twenty years and uses the same methodology—full-time employees grading cards on a 1-10 scale in person. The grade is primarily determined by human judgement and may require a ruler and/or black light. Third-party authenticators frequently receive resubmissions of the same card in hopes of a better grade. The subjectivity and lack of consistency and accuracy in grading leads to a lack of public confidence in the current grading system. PSA's CEO has openly acknowledged that the company struggles to hire and train qualified graders, many of whom now work out of college. Several ongoing lawsuits involve allegations of known card trimming (removing an edge or portion of an edge of a card to remove wear and/or improve centering).

In addition, the proliferation of graded cards has resulted in a more liquid market, with transaction volumes and values increasing on eBay and at various independent auction houses (Heritage, PWCC, etc.). Yet, many cards are still bought and sold “raw” or ungraded where the only supplemental information is independent seller photographs and descriptions. Seller photographs are of varying quality with respect to pixilation, camera angles, and lighting. Buyers are therefore unable to accurately determine the condition and value of a particular card, and may assume it is worth less because it is ungraded.

Many collectors simply want an unbiased opinion of the value of a card and do not intend to sell. Currently, they can manually enter the details of a card (year, set, number), guess the condition, and make their own determination of value. However, evaluating the condition of a card, and its correlation to the existing market, is both time-consuming and difficult to accurately perform. There are likely many collectors who do not assess their card values via third-party graders because of the time and cost.

Recent attempts in the industry have not solved these problems. For instance, PSA recently began advertising a “QuickOpinion” service on eBay, where PSA authenticators will “provide their candid reaction as it pertains to authenticity” for the low price of $10. PSA notes that this service currently only applies to autograph images, but the PSA authenticators only require an eBay item number (and therefore just a photo) to offer their judgement.

### SUMMARY

A goal of the present invention is to eliminate the friction of shipping and the subjectivity of human grading with a smartphone-specific software-based grading service.

Another goal of the present invention is to eliminate the hassle of boxing cards appropriately, shipping and insurance costs, and the approximate two-month wait to receive cards back safely.

Another goal of the present invention is to receive quick and accurate valuations for memorabilia.

Another goal of the present invention is to dramatically reduce the time needed for buyers to scrutinize seller photos for the quality of ungraded cards.

Another goal of the present invention is to reduce the cost of grading a memorabilia such that it should be a “red flag” if a seller does not want to spend to get an accurate portrayal of card quality.

Another goal of the present invention is to aid consumers and collectors in determining a grade of their collectables, such that they will not have to scan the existing universe of graded cards for differences between cards that receive the same grade, despite having no substantiating evidence for those grades.

Another goal of the present invention is to make use of an image classification system trained to recognize, grade, and valuate memorabilia.

Another goal of the present invention is to automate the process of collecting images of memorabilia such that the highest quality information regarding the condition of memorabilia, such as high quality photographs, are collected and used.

Another goal of the present invention is to provide a system that both buyers and sellers can trust to provide consistent grading and valuation based software algorithms.

Another goal of the present invention is to provide a reproducible grade for memorabilia based on a variety of factors.

Another goal of the present invention is to reduce the ability of a collector from manipulating grading and valuations by providing reproducible grades, which may be recorded on an immutable ledger.

In accordance with the above, the present invention relates to a system for grading and valuating memorabilia.

In one aspect of the invention, a system for grading and valuating memorabilia is disclosed as having a computer, a user device in data communication with said computer, the user device having a camera and attributes pertaining to the quality of images taken by said camera, an image of a piece of memorabilia provided to said computer that shows a condition of the memorabilia, a grade associated with the condition of the memorabilia determined by the computer based on at least one of the image and the attributes, the computer providing an identification of the memorabilia to a database, a plurality of images of other memorabilia and a plurality of grades and a plurality of values associated therewith provided to said computer by said database, and a valuation for the memorabilia determined by said computer by comparing the grade for the memorabilia with at least one of the plurality of grades for the other memorabilia and assigning a valuation based on at least one of the corresponding values.

### BRIEF DESCRIPTION OF THE DRAWINGS

FIG. 1 is a schematic drawing of the invention.

### DETAILED DESCRIPTION

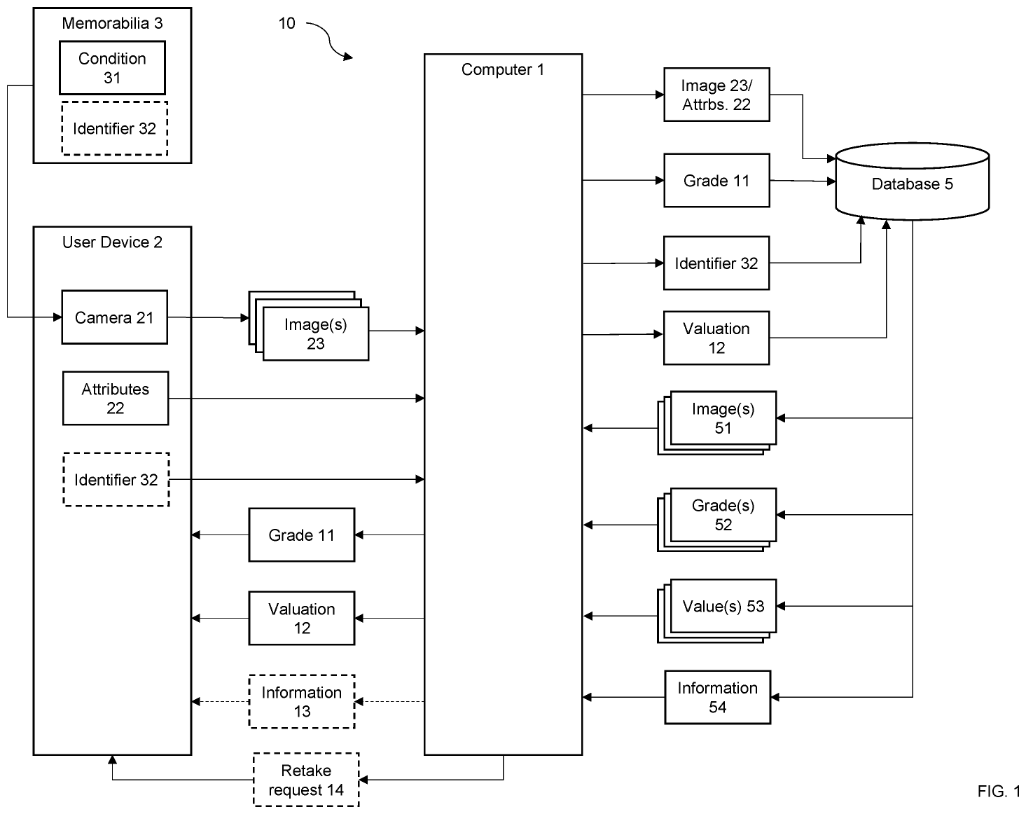

Referring to FIG. 1, the present disclosure describes a system 10 for grading and valuating memorabilia.

The system 10 includes a computer 1. The computer 1 may be a processor, remote computer, computer server, network, or any other computing resource, including mobile devices.

The computer 1 may be in communication with a user device 2. The user device 2 may be a computer, laptop, smartphone, tablet, or other electronic device, including mobile devices, capable of transmitting data to the computer 1. The user device 2 may also include cloud databases accessible to such an electronic device, such as Dropbox or OneDrive. The user device 2 may run an application on a mobile device or smartphone.

The user device 2 may have a camera 21. The camera 21 may be a still image or a video camera. The user device 2 may have attributes 22 pertaining to the quality of images taken by said camera 21. For example, attributes 22 may include set attributes or variable attributes. Attributes 22 may include aperture, shutter speed, ISO, resolution, etc. Attributes 22 may also include information regarding lighting, background, angles, and distance from a subject. The camera 21 may be integrated with or separate from the user device 2. The camera 21 may have its own lighting system, use room lighting, or use a dedicated light box for taking images.

The camera 21 may be used to take an image 23 of a piece of memorabilia 3. The image 23 may be an ultraviolet image, infrared image, or a blacklight image. The image 23 may be one or more images 23.

Memorabilia 3 can include trading cards (such as baseball cards), jerseys, caps, bats, sticks, rackets, balls, pucks, pictures, signatures, or other collectables.

The memorabilia 3 may have a condition 31. The condition 31 may be determined from the physical piece of memorabilia. The condition 31 may be shown in an image 23. The condition 31 may be gradable. In the case of a trading card, the condition 31 may include at least one of corner wear, surface ink quality, centering, edge quality, sizing dimensions, fonts, and more. These condition aspects may be determinable through an image of the card alone. Other condition measurements, such as opacity of cardstock and ink and the weight of a cardstock may be require additional measuring tools, such as backlights and/or a scale.

The memorabilia 3 may also have an identifier 32. The identifier 32 may appear in an image 23 of the memorabilia 3. The identifier 32 may be unique, for example, a unique symbol or barcode. The identifier 32 may be in ink on the memorabilia 3. The identifier 32 may be invisible to the naked eye, such as an identifier 32 made with a UV or infrared ink. The identifier 32 may also be determined by analyzing the memorabilia 3 against images of other memorabilia. The identifier 32 may be used to identify the type of memorabilia (e.g., a baseball card) or the specific card (e.g., a 2021 Topps Aaron Judge card). For example, a barcode or individual serial number may be put on a trading card by a manufacturer to differentiate the same cards within a set. Alternatively, if no such intentional identifier is placed on a card, a digital fingerprint of the card may be determined based on the condition 31 of the card (such as blemish identifiers, centering specifications, corner wear, etc.) whereby a photo can be matched to the existing card image in the database. This digital fingerprint may be treated by the computer 1 as an identifier 32.

The user device 2 may provide one or more images 23 to the computer 1. Attributes 22 regarding the camera 21 or the image 23 may also be provided by the user device 2 to the computer 1. The user device 2 may also provide an identifier 32 to the computer 1.

The computer 1 may determine a grade 11 for the memorabilia based on at least one of the image 23 and attributes 22. The computer may also base the grade 11 on the identifier 32. To determine the grade 11, the computer 1 may use image classification techniques to determine various sub-grades regarding the condition 31 of the memorabilia. For example, the computer 1 may use pixel counting techniques to determine if a trading card is centered, and the width of the edges. These sub-grades may be combined into a grade 11. The raw scores may be weighted to reach the grade 11.

The grade 11 may also take into account the specific attributes 22. For example, a lower resolution camera may introduce uncertainty to the grade 11, such that the computer assigns a lower grade 11 or a grade range 11. Comparatively, a higher resolution camera 21 may not introduce that uncertainty, reducing the need for a grade range.

Grades 11 may include a time stamp and be associated with the identifier 32 to render the grade valid and permanent. The grade 11 may be supplemented by a visual description of the card's physical attributes. For example, the computer 1 may auto-generate a description of the memorabilia 3 based on the subgrades, or receive a description from the memorabilia 3 owner.

In instances where the computer cannot determine a grade 11 based on the image 23 and attributes 22, the computer 1 may send a request 14 to the user device 2 for another image 23 of the memorabilia. The request 14 may specify the type of image (e.g., an image of the back of a trading card, an enlarged view of a corner, or a UV image). The computer 1 may digitally stitch multiple images 23 together. For example, various enlarged images of the memorabilia 3 could be stitched together to achieve a higher resolution image 23 than otherwise permitted by the camera 21.

The computer 1 may determine the type or specific piece of memorabilia 3 based on the image 23 and/or identifier 32. For example, the computer 1 may be able to determine that a baseball card is for a specific year and player based on the image 23. In addition, if the memorabilia 3 has an identifier 32, the specific piece of memorabilia may be determined.

The computer 1 may be in data communication with a database 5. The database 5 may store and retrieve information regarding the system 10, including the image 23, attributes 22 and/or identifier 32. The database 5 may also store a grade 11 or valuation 12. When storing information, the database 5 may include additional meta-information. For example, it may store the identity of the user device 2 from which the data came, a date and time stamp, or any other meta-information that may be useful to the system 10.

The database 5 may include images 51 of other memorabilia, and grades 52 and values 53 therefor. The database 5 may be provided by a third party such as an auction house or authenticator. Data regarding previously graded or sold memorabilia may be retrieved from the database 5. For instance, images 51, grades 52, and values 53 may be retrieved. The computer 1 may retrieve images 51, grades 52, and values 53 based on the grade 11 for memorabilia 3. The values 53 may include a timestamp and dollar amount for when they were values (i.e., a year the memorabilia was sold and for how much). For instance, if the memorabilia 3 is a 1952 Mickey Mantle card, the computer 1 may retrieve all images 51, grades 52, and values 53 for other 1952 Mickey Mantle cards.

Information 54 may also be retrieved from the database 5. The information 54 may be associated with a specific piece of memorabilia (e.g., an ownership history) or the type of memorabilia (e.g., statistics or biographical information regarding a player on a baseball card). The information may include at least one of a provenance record, a manufacturing record, storage records, grading records, valuation records, sales records, and/or other historical information regarding the memorabilia. The information 54 may include text, images, audio, and/or video.

The computer 1 may determine a valuation 12 for the memorabilia 3 based on the images 23, grade 11, images 51, grades 52, and/or values 53. For example, the computer 1 may compare images 23 with images 52 and/or grade 11 with grades 52 to determine the closest match. The computer 1 may estimate a valuation 12 for the memorabilia based on the associated values 53. The computer may take into account the timestamps associated with values 53, adjusting the valuation 12 higher or lower.

The computer 1 may provide the grade 11, valuation 12, and/or information 13 to the user device 2.

The database 5 may include an immutable ledger where images 23, 51, grades 11, 52, identifiers 32, attributes 22, and values 12, 53 may be stored and retrieved. In this way, no one person could modify any records related to previously graded and valued memorabilia. In addition, multiple requests to grade and value the same memorabilia would be detected by the ledger, resulting in the same grade and value.

In compliance with the statute, the present teachings have been described in language more or less specific as to structural and methodical features. It is to be understood, however, that the present teachings are not limited to the specific features shown and described, since the systems and methods herein disclosed comprise preferred forms of putting the present teachings into effect.

For purposes of explanation and not limitation, specific details are set forth such as particular architectures, interfaces, techniques, etc. in order to provide a thorough understanding. In other instances, detailed descriptions of well-known devices, circuits, and methods are omitted so as not to obscure the description with unnecessary detail.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second,” etc. for different features/components of the present disclosure are only intended to distinguish the features/components from other similar features/components and not to impart any order or hierarchy to the features/components.

To aid the Patent Office and any readers of any patent issued on this application in interpreting the claims appended hereto, Applicant states that it does not intend any of the claims or claim elements to invoke 35 U.S.C. 112(f) unless the words “means for” or “step for” are explicitly used in the particular claim.

While the present teachings have been described above in terms of specific embodiments, it is to be understood that they are not limited to these disclosed embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

What is claimed is:

1. A system for grading and valuating memorabilia, comprising:
a computer;
a user device in data communication with said computer;
the user device having a camera and attributes pertaining to the quality of images taken by said camera;
an image of a piece of memorabilia provided to said computer that shows a condition of the memorabilia;
a grade associated with the condition of the memorabilia determined by the computer based on at least one of the image and the attributes;
the computer providing an identification of the memorabilia to a database;
a plurality of images of other memorabilia and a plurality of grades and a plurality of values associated therewith provided to said computer by said database;
a valuation for the memorabilia determined by said computer by comparing the grade for the memorabilia with at least one of the plurality of grades for the other memorabilia and assigning a valuation based on at least one of the corresponding values.

2. The system of claim 1, the computer considering the quality of the image provided by the user device based on the attributes provided by the user device.

3. The system of claim 1, the computer providing at least one of the grade and valuation to the user device.

4. The system of claim 1, the computer storing at least one of the image, grade, identifier, and/or attributes in the database.

5. The system of claim 1, the identifier being a unique symbol on the memorabilia.

6. The system of claim 1, the identifier being part of ink used on the memorabilia.

7. The system of claim 1, the identifier being visible in infrared or ultraviolet light.

8. The system of claim 1, wherein the identifier for the memorabilia is determined by analyzing the image against images of other memorabilia.

9. The system of claim 1, the image being an ultraviolet image, infrared image, or a blacklight image.

10. The system of claim 1, the grade including at least one of a timestamp and a unique identifier for the memorabilia generated by said computer.

11. The system of claim 1, the computer analyzing the image to determine the grade for the memorabilia, including for at least one of corner wear, surface ink quality, centering, edge quality, sizing dimensions, fonts, opacity of cardstock, opacity of ink, and weight of cardstock.

12. The system of claim 1, the grade containing a plurality of sub-grades which are weighted to determine an overall grade.

13. The system of claim 1, the computer comparing the image of the memorabilia and at least one of the plurality of images of other memorabilia to determine a valuation.

14. The system of claim 1, the computer providing a request to retake an image to the user device.

15. The system of claim 1, further comprising a lightbox for providing lighting while taking the image.

16. The system of claim 1, wherein a plurality of images are provided to the computer, the computer combining the plurality of images into one image that is used to determine the grade of the memorabilia.

17. The system of claim 1, the database providing information regarding the memorabilia, the information regarding the memorabilia being provided to said user.

18. The system of claim 17, the information regarding the memorabilia being at least one of biographical or statistical information regarding a person associated with the memorabilia and a history of the memorabilia object.

19. The system of claim 17, the information regarding the memorabilia including at least one of text, an image, an audio recording and a video.

20. The system of claim 1, further comprising:
the computer in data communication with an immutable ledger;
the computer retrieving information from the immutable ledger regarding the memorabilia based at least on the identifier.

21. The system of claim 20, wherein the information is at least one of a provenance record, a manufacturing record, storage records, grading records, valuation records, sales records, and/or other historical information regarding the memorabilia.

22. The system of claim 20, wherein the database is the immutable ledger.
